(19) United States
(12) Patent Application Publication
(10) Pub. No.: US 2026/0159675 A1
(43) Pub. Date: Jun. 11, 2026

(54) PROCESS FOR CONTROLLING THE SWELL RATIO OF A POLYETHYLENE COMPOSITION

(71) Applicant: Basell Polyolefine GmbH, Wesseling (DE)

(72) Inventors: Ulf Schueller, Frankfurt (DE); Gerhardus Meier, Frankfurt (DE)

(73) Assignee: Basell Polyolefine GmbH, Wesseling (DE)

(21) Appl. No.: 19/124,438

(22) PCT Filed: Oct. 26, 2023
(86) PCT No.: PCT/EP2023/079931

§ 371 Date: Apr. 25, 2025

(30) Foreign Application Priority Data
Oct. 26, 2022 (EP) 22203732.7

(51) Int. Cl. C08L 23/0807

(52) U.S. Cl. CPC C08L 23/0815; C08L 2203/16; C08L 2205/025; C08L 2205/03; C08L 2308/00; C08L 2314/02

(57) ABSTRACT

A process for controlling the swell ratio of a polyethylene composition, made from or containing three or more polyethylene components and having a specified melt flow rate, including the steps of (a) preparing the polyethylene composition in a polymerization apparatus including three or more polymerization zones in the presence of a polymerization catalyst and hydrogen as molecular weight regulator and (b) selecting different ratios of hydrogen to ethylene in the polymerization zones, thereby forming the three or more polyethylene components which differ in average molecular weight and effecting the swell ratio of the polyethylene composition, wherein a first polyethylene component has the highest average molecular weight and a second polyethylene components has the second-highest average molecular weight.

### FIELD OF THE DISCLOSURE

In general, the present disclosure relates to the field of chemistry. More specifically, the present disclosure relates to polymer chemistry. In particular, the present disclosure relates to a process for preparing a polyethylene composition made from or containing multimodal polyethylene.

### BACKGROUND OF THE DISCLOSURE

In some instances, polyethylene is commercially successful because of low production costs and flexibility to produce various materials for satisfying property and processability specifications. In some instances, polyethylene is used to prepared blow molded articles.

In some instances, the usefulness of polyethylene for different applications is determined by swell ratio or “die swell ratio”. In some instances, a high swell ratio increases the weight of the product. In some instances, a low swell ratio renders the product difficult for forming additional features, such as side handles on a container. In some instances, applications dictate that products have a swell ratio within a tight range.

In some instances and depending on the application, the acceptable swell ratio of the product varies. In some instances, the swell ratio for a blow molding process to produce canisters at high speed in continuous mode differs from the swell ratio for small blow molding applications or large blow molding applications, such as large containers or L-ring drums.

### SUMMARY OF THE DISCLOSURE

In a general embodiment, the present disclosure provides a process for controlling the swell ratio of a polyethylene composition, made from or containing three or more polyethylene components and having a specified melt flow rate, including the steps of:
preparing the polyethylene composition in a polymerization apparatus including three or more polymerization zones in the presence of a polymerization catalyst and hydrogen as molecular weight regulator; and
selecting different ratios of hydrogen to ethylene in the polymerization zones, thereby forming the three or more polyethylene components which differ in average molecular weight and effecting the swell ratio of the polyethylene composition,
wherein a first polyethylene component has the highest average molecular weight and a second polyethylene component has the second-highest average molecular weight, wherein,
for increasing the swell ratio, the selecting step includes a step of increasing the difference between the average molecular weight of the first polyethylene component and the average molecular weight of the second polyethylene component and,
for decreasing the swell ratio, the selecting step includes a step of decreasing the difference between the average molecular weight of the first polyethylene component and the average molecular weight of the second polyethylene component.

In some embodiments, the polyethylene composition is a multimodal polyethylene composition.

In some embodiments, the step of increasing or decreasing the difference between the average molecular weight of the first polyethylene component and the average molecular weight of the second polyethylene component is or includes a step of modifying the ratio of hydrogen to ethylene (a) in the polymerization zones in which the first polyethylene component is prepared or (b) in the polymerization zones in which the second polyethylene component is prepared. In some embodiments, the ratio of hydrogen to ethylene is modified by adjusting the hydrogen feed to the respective polymerization zones.

In some embodiments, the step of increasing or decreasing the difference between the average molecular weight of the first polyethylene component and the average molecular weight of the second polyethylene component is or includes a step of changing the temperature (a) in the polymerization zones in which the first polyethylene component is prepared or (b) in the polymerization zones in which the second polyethylene component is prepared.

In some embodiments and for keeping the melt flow rate of the polyethylene composition at the specified value while increasing or decreasing the difference between the average molecular weight of the first polyethylene component and the average molecular weight of the second polyethylene component, the process further includes the step of changing the polymerization conditions in one or more polymerization zones which are neither the polymerization zone in which the first polyethylene component is prepared nor the polymerization zone in which the second polyethylene component having the second-highest average molecular weight is prepared.

In some embodiments and for keeping the melt flow rate of the polyethylene composition at the specified value while increasing or decreasing the difference between the average molecular weight of the first polyethylene component and the average molecular weight of the second polyethylene component, the process further includes the step of changing the polymerization conditions in the polymerization zone in which the second polyethylene component is prepared.

In some embodiments and while increasing or decreasing the swell ratio, the process further includes the step of maintaining constant the polymerization conditions in one or more polymerization zones, which are neither the polymerization zone in which the first polyethylene component is prepared nor the polymerization zone in which the second polyethylene component is prepared.

In some embodiments, the polymerization apparatus includes a series of three subsequent polymerization reactors.

In some embodiments, the polymerization apparatus includes a series of a fluidized-bed reactor and a multizone circulating reactor.

In some embodiments, the process further includes the step of removing a gas fraction from the reaction mixture in a gas separator between at least two polymerization zones.

In some embodiments, the present disclosure provides a process for preparing at least two types of polyethylene composition having a specified melt flow rate and different swell ratios, including the steps of:
polymerizing ethylene in the presence of a polymerization catalyst and hydrogen as a molecular weight regulator in a series of polymerization reactors including three or more polymerization zones,
selecting different ratios of hydrogen to ethylene in the polymerization zones, thereby forming three or more polyethylene components which differ in average molecular weight,
wherein a first polyethylene component has the highest average molecular weight and a second polyethylene component has the second-highest average molecular weight,
wherein,
for increasing the swell ratio, the selecting step includes a step of increasing the difference between the average molecular weight of the first polyethylene component and the average molecular weight of the second polyethylene component, and
for decreasing the swell ratio, the selecting step includes a step of decreasing the difference between the average molecular weight of the first polyethylene component and the average molecular weight of the second polyethylene component.

In some embodiments, the at least two types of polyethylene composition are prepared subsequently without interruption of the process.

In some embodiments, at least one of the at least two types of polyethylene composition is a high density polyethylene composition having a density of from 0.940 to 0.968 g/cm³. In some embodiments, the polyethylene compositions are high density polyethylene compositions having a density of from 0.940 to 0.968 g/cm³.

### BRIEF DESCRIPTION OF THE DRAWINGS

While multiple embodiments are disclosed, still other embodiments will become apparent to those skilled in the art from the following detailed description. As will be apparent, certain embodiments, as disclosed herein, are capable of modifications in various aspects, without departing from the spirit and scope of the claims as presented herein. Accordingly, the drawings and detailed description are to be regarded as illustrative in nature and not restrictive.

FIG. 1 is a schematic of a set-up for preparing a polyethylene composition, wherein the swell ratio of a polymer composition is controlled.

FIG. 2 is a schematic of a set-up for preparing a polyethylene composition, wherein the swell ratio of the composition is controlled.

### DETAILED DESCRIPTION OF THE DISCLOSURE

In some embodiments, the melt flow rate is specified by an application or a customer specification. In some embodiments, the specified melt flow rate is about 2.7, alternatively about 5.5, alternatively about 7.5, alternatively about 11, alternatively about 30. In some embodiments and as used herein, the term “about” includes variations of ±25% from the specified value. In some embodiments, the specified melt flow rate encompasses a range from 2.0 to 3.0, alternatively from 4.5 to 6.5, alternatively from 6.5 to 8.5, alternatively from 9 to 13, alternatively from 23 to 37. In some embodiments and within these alternative ranges, the swell ratio is controlled from 120% to 250% by adapting the difference between the average molecular weight of the first polyethylene component and the average molecular weight of the second polyethylene component.

As used herein, the term “comprising” refers to “including”, “encompassing”, or “containing”. As used herein, the term “comprising” includes the explicitly recited elements and allows for the presence of other non-recited elements. In some embodiments and as used herein, the term “comprising” has the limiting meaning “consisting of”. As such, “comprising certain features” includes the meaning of consisting of the certain features, whether explicitly stated or not. In some embodiments and as used herein, the term “comprising” includes the meaning “consisting essentially of”.

As used herein, the term “swell” or “die swell” refers to the expansion of a free form parison (or annular tube of molten plastic) upon exit from a die geometry (including convergent, divergent, straight, or otherwise), after the molten precursor resin was delivered under pressure to the die by an extruder. Hence, die swell is an instance where a polymer stream is compressed by entrance into a die and followed by a partial recovery back to the former shape and volume of the polymer after exiting the die.

In some embodiments, the present disclosure provides a process for controlling the swell ratio of a polyethylene composition having a specified melt flow rate. In some embodiments, the polyethylene composition is a multimodal ethylene copolymer. As used herein, the term “multimodal” refers to the modality of the resulting ethylene copolymer and indicates that the ethylene copolymer is made from or containing at least three fractions of polymer which are obtained under different reaction conditions, independently. In some embodiments, the modality of the resulting ethylene polymer is recognized as separated maxima in a gel permeation chromatography (GPC) curve. In some embodiments, the modality of the resulting ethylene polymer is not recognized as separated maxima in a gel permeation chromatography (GPC) curve. In some embodiments, the different polymerization conditions are achieved by using different hydrogen concentrations, using different comonomer concentrations, or both in different polymerization zones. In some embodiments, the polyethylene composition is a multimodal ethylene copolymer having exactly three modalities.

In some embodiments, the ethylene copolymers are prepared by polymerizing ethylene and one or more C₃-C₁₂-1-alkenes in the presence of a polymerization catalyst. In some embodiments, the C₃-C₁₂-1-alkenes are linear or branched. In some embodiments, the C₃-C₁₂-1-alkenes are linear C₃-C₁₀-1-alkenes or branched C₂-C₁₀-1-alkenes. In some embodiments, the linear C₃-C₁₀-1-alkenes are selected from the group consisting of propylene, 1-butene, 1-pentene, 1-hexene, 1-heptene, 1-octene, and 1-decene. In some embodiments, the branched C₂-C₁₀-1-alkene is 4-methyl-1-pentene. In some embodiments, the ethylene copolymers are prepared by polymerizing ethylene with mixtures of two or more C₃-C₁₂-1-alkenes. In some embodiments, the comonomers are C₃-C₈-1-alkenes. In some embodiments, the C₃-C₈-1-alkenes are selected from the group consisting of 1-butene, 1-pentene, 1-hexene, 1-heptene, and 1-octene. In some embodiments, the amount of units derived from incorporated comonomers is from 0.01 wt % to 25 wt. %, alternatively from 0.05 wt % to 15 wt. %, alternatively from 0.1 wt. % to 12 wt %. In some embodiments, ethylene is copolymerized with from 0.1 wt. % to 12 wt. % of 1-hexene or 1-butene, alternatively with from 0.1 wt. % to 12 wt. % of 1-hexene.

In some embodiments, the multimodal ethylene copolymer is an ethylene-1-hexene copolymer, that is, an ethylene copolymer obtained by copolymerizing ethylene as the main monomer and 1-hexene as the comonomer.

In some embodiments, the multimodal ethylene copolymer is made from or containing at least two comonomers. In some embodiments, the multimodal ethylene copolymer is a terpolymer or a copolymer made from or containing more than two kinds of comonomers. In some embodiments, the ethylene copolymers are made from or containing at least 1-hexene and 1-butene as comonomers.

In some embodiments, the polymerization is carried out using olefin polymerization catalysts. In some embodiments, the polymerization is carried out using Phillips catalysts based on chromium oxide, using titanium-based Ziegler- or Ziegler-Natta-catalysts, using single-site catalysts, or using mixtures of such catalysts. As used herein, single-site catalysts are catalysts based on chemically uniform transition metal coordination compounds. In some embodiments, mixtures of two or more of these catalysts are used for the polymerization of olefins. In some embodiments, mixed catalysts are referred to as hybrid catalysts.

In some embodiments, the catalysts are of the Ziegler type. In some embodiments, the catalysts are of the Ziegler type are made from or containing a compound of titanium or vanadium, a compound of magnesium and optionally an electron donor compound and/or a particulate inorganic oxide as a support material. In some instances, high density polyethylene blow molding compositions are made with chromium catalysts. In some instances, the ability to change the swell ratio of products produced by chromium catalysts is limited. In some instances, the stress cracking resistance ESCR of products made with chromium catalysts underperforms when compared to the stress cracking resistance ESCR of multimodal products made with Ziegler-Natta catalysts. In some embodiments, catalysts of the Ziegler type are polymerized in the presence of a cocatalyst. In some embodiments, cocatalysts are organometallic compounds of metals of Groups 1, 2, 12, 13 or 14 of the Periodic Table of Elements, alternatively organometallic compounds of metals of Group 13, alternatively organoaluminum compounds. In some embodiments, cocatalysts are organometallic alkyls, organometallic alkoxides, or organometallic halides.

In some embodiments, the organometallic compounds are selected from the group consisting of lithium alkyls, magnesium alkyls, zinc alkyls, magnesium alkyl halides, aluminum alkyls, silicon alkyls, silicon alkoxides and silicon alkyl halides. In some embodiments, the organometallic compounds are selected from the group consisting of aluminum alkyls and magnesium alkyls. In some embodiments, the organometallic compounds are selected from the group consisting of aluminum alkyls and magnesium alkyls. In some embodiments, the organometallic compounds are aluminum alkyls, alternatively trialkylaluminum compounds or compounds of this type in which an alkyl group is replaced by a halogen atom. In some embodiments, the halogen atom is chlorine or bromine. In some embodiments, the aluminum alkyls are selected from the group consisting of trimethylaluminum, triethylaluminum, triisobutylaluminum, tri-n-hexylaluminum, diethylaluminum chloride, or mixtures thereof.

In some embodiments, the process is a polymerization process carried out in a series of at least two reactors.

In some embodiments, the polymerization process is carried out in a gas-phase. In some embodiments, the process is carried out in two or more gas-phase polymerization reactors. In some embodiments, the process is carried out in exactly two gas-phase polymerization reactors arranged in series. In some embodiments, the gas-phase polymerization reactors of the series of reactors are horizontally or vertically stirred gas-phase reactors, multizone circulating reactors, or fluidized-bed reactors. In some embodiments, the gas-phase polymerization reactors of the series of reactors are of the same type. In some embodiments, the gas-phase polymerization reactors of the series of reactors are different types of gas-phase polymerization reactors. In some embodiments, the gas-phase polymerization in the reactor series is preceded by a pre-polymerization stage. In some embodiments, the pre-polymerization stage is carried out as suspension polymerization. In some embodiments, the suspension polymerization is carried out in a loop reactor. In some embodiments, the polymerization is carried out in a series of reactors including a fluidized-bed reactor as a first reactor and, arranged downstream thereof, a multizone circulating reactor.

Fluidized-bed reactors are reactors, wherein the polymerization takes place in a bed of polyolefin particles maintained in a fluidized state by feeding in a reaction gas mixture at the lower end of a reactor and taking off the gas again at the top of the fluidized-bed reactor. In some embodiments, the gas is fed below a gas distribution grid, having the function of dispensing the gas flow. The reaction gas mixture is then returned to the lower end of the reactor via a recycle line equipped with a centrifugal compressor and a heat exchanger for removing the heat of polymerization. In some embodiments, the flow rate of the reaction gas mixture fluidizes the bed of finely divided polymer present in the polymerization zone and removes the heat of polymerization effectively.

In some embodiments, the multizone circulating reactors are as described in Patent Cooperation Treaty Publication Nos. WO 97/04015 A1 and WO 00/02929 A1. In some embodiments, the multizone circulating reactors have two interconnected polymerization zones, a riser, wherein the growing polyolefin particles flow upward under fast fluidization or transport conditions, and a downcomer, wherein the growing polyolefin particles flow downward in a densified form under the action of gravity. The polyolefin particles, leaving the riser, enter the downcomer, and the polyolefin particles, leaving the downcomer, are reintroduced into the riser, thereby establishing a circulation of polymer between the two polymerization zones. In some embodiments, the polymer is passed alternately a plurality of times through these two zones. In such polymerization reactors, a solid/gas separator is arranged above the downcomer to separate the polyolefin and reaction gaseous mixture coming from the riser. The growing polyolefin particles enter the downcomer, and the separated reaction gas mixture of the riser is continuously recycled through a gas recycle line to one or more points of reintroduction into the polymerization reactor. In some embodiments, the major part of the recycle gas is recycled to the bottom of the riser. The recycle line is equipped with a centrifugal compressor, and a heat exchanger for removing the heat of polymerization. In some embodiments, a line for feeding catalyst or a line for feeding polyolefin particles coming from an upstream reactor is arranged on the riser. In some embodiments, a polymer discharge system is located in the bottom portion of the downcomer. In some embodiments, make-up monomers, comonomers, hydrogen, inert components, or a combination thereof is introduced at various points along the riser and the downcomer.

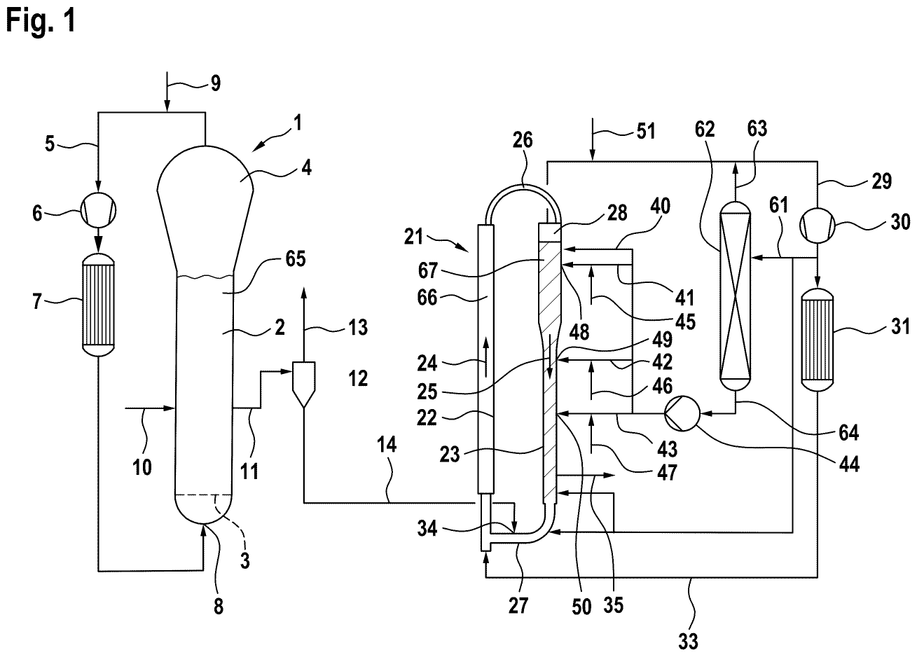

FIG. 1 is a schematic of a set-up for preparing a polyethylene composition, wherein the swell ratio of a polymer composition is controlled. The set-up includes a series of a fluidized-bed reactor (1) arranged upstream of a multizone circulating reactor (21).

In some embodiments and in the fluidized-bed reactor (1), ethylene is polymerized. In some embodiments, ethylene is polymerized in the presence of propane as an inert diluent and hydrogen as a molecular weight regulator. The fluidized-bed reactor (1) includes a fluidized bed (2) of polyethylene particles, a gas distribution grid (3), and a velocity reduction zone (4). In some embodiments, the velocity reduction zone (4) is of increased diameter compared to the diameter of the fluidized bed portion of the reactor. An upwardly flow of gas fed through the gas distribution grid (3), placed at the bottom portion of the reactor (1), keeps the polyethylene bed in a fluidized state. The gaseous stream of the reaction gas leaving the top of the velocity reduction zone (4) via recycle line (5) is compressed by compressor (6), transferred to a heat exchanger (7), wherein the reaction gas is cooled, and then recycled to the bottom of the fluidized-bed reactor (1) at a point below the gas distribution grid (3) at position (8). In some embodiments, a combination of make-up monomers, molecular weight regulators such as hydrogen, and propane as inert diluent is fed into the reactor (1) at various positions. In some embodiments, a combination of make-up monomers, molecular weight regulators and propane is fed via line (9) upstream of the compressor (6). In some embodiments, catalyst is fed into the fluidized-bed reactor (1) via line (12). In some embodiments, line (12) is placed in the lower part of the fluidized bed (2).

In some embodiments, the polyethylene particles obtained in the fluidized-bed reactor (1) are discontinuously discharged via line (11) and fed to a solid/gas separator (12), thereby preventing entry of the gaseous mixture, coming from fluidized-bed reactor (1), into the second gas-phase reactor. The gas leaving the solid/gas separator (12) exits the reactor via line (13) as off-gas, while the separated polyolefin particles are fed via line (14) to the second gas-phase reactor.

In some embodiments, the second gas-phase reactor is a multizone circulating gas-phase reactor (21) having two reaction zones, a riser (22) and a downcomer (23), which are repeatedly passed by the polyethylene particles. Within the riser (22) and under fast fluidization conditions, the polyethylene particles flow upward along the direction of arrow (24). Within the downcomer (23) and under the action of gravity, the polyethylene particles flow downward along the direction of arrow (25). The riser (22) and the downcomer (23) are interconnected by an upper interconnection bend (26) and a lower interconnection bend (27).

After flowing through the riser (22), the polyethylene particles and the gaseous mixture leave the riser (22) and are conveyed through the upper interconnection bend (26) to a solid/gas separation zone (28). In some embodiments, the solid/gas separation is effected by a centrifugal separator like a cyclone. From the separation zone (28), the polyethylene particles enter the downcomer (23).

The gaseous mixture leaving the separation zone (28) is recycled to the riser (22) via a recycle line (29), equipped with a compressor (30) and a heat exchanger (31). Downstream of the heat exchanger (31), the recycle gas is conveyed to the bottom of the riser (22) via line (33), thereby establishing fast fluidization conditions therein.

The polyethylene particles coming from the first gas-phase reactor via line (14) enter the multizone circulating gas-phase reactor (21) at the lower interconnection bend (27) in position (34).

In some embodiments, the polyethylene particles obtained in the multizone circulating reactor (21) are continuously discharged from the bottom part of the downcomer (23) via the discharge line (35).

In some embodiments and to prevent the reaction gas mixture of the riser (22) from entering the downcomer (23), a liquid stream is fed as a barrier fluid into the upper part of the downcomer via line (40). In some embodiments, the liquid for generating the barrier originates from partially condensing recycle gas mixture and separating liquid and gaseous components in a separating vessel (62), for example, a column. The separating vessel (62) is fed with compressed recycle gas via line (61) that branches off the recycle line (29) between the compressor (30) and the heat exchanger (31). In some embodiments, the separated gas-phase is reintroduced into the recycle line via line (63). In some embodiments, the liquid fraction is withdrawn from the separating vessel (62) via line (64) and fed to the downcomer (23) through lines (40), (41), (42) and (43) by a pump (44). In some embodiments, a combination of make-up monomers, make-up comonomers, optionally inert gases, or process additives is introduced via lines (45), (46) and (47) into lines (41), (42) and (43), respectively, and then fed into the downcomer (23) at monomer feeding points (48), (49), and (50).

In some embodiments, a combination of make-up monomers, make-up comonomers, optionally inert gases, or process additives are introduced into the recycle line (29) via line (51).

In some embodiments, the polymerization apparatus includes three polymerization zones, a first polymerization zone (65) formed by the fluidized-bed reactor (1), a second polymerization zone (66) formed by the riser (22), and a third polymerization zone (67) formed by the downcomer (23). Each polymerization zone differs in the ratio of hydrogen to ethylene, thereby forming three polyethylene components, which differ in the average molecular weight. In the first polymerization zone (65), a third polyethylene component having the lowest molecular weight is produced. In the second polymerization zone (66), a second polyethylene component having a medium molecular weight is produced. In the third polymerization zone (67), a first polyethylene component having a higher molecular weight is produced.

Without being bound to a particular theory, it is believed that the swell ratio of the final polyethylene composition is controllable by manipulating the difference between the average molecular weight of the first polyethylene component having the highest average molecular weight and the average molecular weight of the second polyethylene component having the second-highest average molecular weight. In some embodiments and for increasing the swell ratio, the difference between the average molecular weight of the first polyethylene component and the average molecular weight of the second polyethylene component is increased. In some embodiments and for decreasing the swell ratio, the difference between the average molecular weight of the first polyethylene component and the average molecular weight of the second polyethylene component is decreased.

In some embodiments, the step of increasing or decreasing the difference between the average molecular weight of the first polyethylene component and the average molecular weight of the second polyethylene component includes a step of modifying the ratio of hydrogen to ethylene (a) in the polymerization zones in which the first polyethylene component is prepared or (b) in the polymerization zones in which the second polyethylene component is prepared. In some embodiments, the ratio of hydrogen to ethylene in the polymerization zone, in which the first polyethylene component is prepared, is adjusted between 0.002 to 0.500. In some embodiments, the ratio of hydrogen to ethylene in the polymerization zone, in which the second polyethylene component is prepared, is adjusted between 0.020 to 1.000. In some embodiments, the ratio of hydrogen to ethylene is adjusted by manipulating the hydrogen feed to the respective polymerization zone.

In some embodiments, the hydrogen to ethylene feed to the downcomer (23) is manipulated by changing the conditions of the column. In some embodiments, the hydrogen to ethylene feed to the downcomer (23) is manipulated by changing the conditions of the column by increasing the heat introduced to the bottom of the column. In some embodiments, the composition leaving the column is analyzed. In some embodiments, the flow rate of the heating fluid to the heat exchanger (not shown in FIG. 1) at the bottom of the column is adjusted either manually or automatically until the hydrogen content is reached.

In some embodiments, obtaining the difference between the average molecular weight of the first polyethylene component and the average molecular weight of the second polyethylene component includes a step of changing the temperature (a) in the polymerization zones in which the first polyethylene component is prepared or (b) in the polymerization zones in which the second polyethylene component is prepared.

In some embodiments, the melt flow rate of the polyethylene composition is kept at a specific value while increasing or decreasing the difference between the average molecular weight of the first polyethylene component and the average molecular weight of the second polyethylene component. In some embodiments and while increasing or decreasing the swell ratio, the melt flow rate is kept constant by adjusting the polymerization conditions in one or more of the polymerization zones.

In some embodiments and while maintaining the melt flow rate of the polyethylene composition at the specified value, the process further includes the step of adjusting the polymerization conditions in a polymerization zone, which is neither a polymerization zone in which the first polyethylene component nor the second polyethylene component is prepared.

In some embodiments and while maintaining the melt flow rate of the polyethylene composition at the specified value and increasing or decreasing the difference between the average molecular weight of the first polyethylene component and the average molecular weight of the second polyethylene component, the process further includes adjusting the polymerization conditions in the first polymerization zone (65), that is, a polymerization zone in which neither the first polyethylene component nor the second polyethylene component is prepared.

In some embodiments, the reaction conditions in a polymerization zone that is neither the polymerization zone in which the first polyethylene component is prepared nor the polymerization zone in which the second polyethylene component is prepared, are kept constant. For example, FIG. 1 shows the polymerization zone as the first polymerization zone (65). In some embodiments, the melt flow rate of the polyethylene composition is further adjusted by manipulating the hydrogen to ethylene ratio in the second polymerization zone, that is the polymerization zone in which the second polyethylene component is prepared.

In some embodiments, the process further includes the step of analyzing the hydrogen to ethylene ratio for each polymerization zone. In some embodiments, the ratio is analyzed via chromatography, such as gas chromatography.

In some embodiment, the process further includes the step of analyzing the final polyethylene composition and adjusting the hydrogen feed to the respective polymerization zone, until the polyethylene composition has a specified melt flow index within a predetermined range and a specified swell ratio within a predetermined range. In some embodiments, this step is computer implemented. In some embodiments, the step is achieved manually.

In some embodiments, the gaseous stream withdrawn from the polymerization apparatus is fed to an analyzer. In some embodiments, the analyzer is a gas chromatograph, a Raman probe, an IR detector, a mass spectrometer, or a thermal conductivity detector. In some embodiments, the analyzer is a gas chromatograph.

In some embodiments and before being introduced into the analyzer, the gaseous stream is passed through a bed of particulate solid, having at the surface chemical groups which are reactive with the organometallic compound.

In some embodiments, the particulate solid, having at the surface chemical groups which are reactive with the organometallic compound, is a porous material. In some embodiments, the porous material is selected from the group consisting of talc, a sheet silicate, and an inorganic oxide.

In some embodiments, the inorganic oxides are selected from the group consisting of oxides of the elements of groups 2, 3, 4, 5, 13, 14, 15 and 16 of the Periodic Table of the Elements. In some embodiments, the inorganic oxides are selected from the group consisting of oxides or mixed oxides of the elements calcium, aluminum, silicon, magnesium, or titanium. In some embodiments, the inorganic oxides are ZrO₂ or B₂O₃. In some embodiments, the oxides are silicon dioxide, aluminum oxide, or silicon aluminum mixed oxides. In some embodiments, the silica oxides are in the form of a silica gel or a pyrogenic silica. In some embodiments, the mixed oxide is calcined hydrotalcite. In some embodiments, the silica has the formula SiO₂·a Al₂O₃, where a is from 0 to 2, alternatively from 0 to 0.5. In some embodiments, the particles of the particulate solid are in granular form. In some embodiments, the particles of the particulate solid are in spray-dried form, wherein the particles of the particulate solid are made from or containing particles having a mean particle diameter of from 5 nm to 5 μm.

In some embodiments, the particulate solid, having at the surface chemical groups which are reactive with the organometallic compound, is built of particles having a mean particle diameter in the range from 50 μm to 10 mm, alternatively from 200 μm to 5 mm. In some embodiments, the particulate solid has a specific surface area in the range from 200 m²/g to 1000 m²/g, alternatively from 500 m²/g to 800 m²/g, determined by gas adsorption according to the BET method as specified in ISO 9277:2010.

In some embodiments, the chemical groups at the surface of the particulate solid which are reactive with the organometallic compound are OH groups, adsorbed water, or strained Si—O—Si bridges. In some embodiments, the particulate solids are calcinated solids, and the chemical groups at the surface of the particulate solid which are reactive with the organometallic compound are strained Si—O—Si bridges.

In some embodiments, the particulate solid is a silica gel which is equipped with a humidity indicator.

In some embodiments, the gaseous stream withdrawn from the polymerization apparatus is a continuous gas stream withdrawn at a flow rate of from 1 Nl/h to 500 Nl/h, alternatively from 5 Nl/h to 350 Nl/h, alternatively from 10 Nl/h to 250 Nl/h. As used herein, the unit “NI” refers to a norm liter, which is the amount of a gas having a volume of one liter at the norm conditions of 101325 Pa (=1.01325 bar) and 0° C. As used herein, 1 g/h corresponds to about 11.9 Nl/h.

In some embodiments, the analyzer is provided with the sample of the gaseous stream at intervals.

In some embodiments, two or more, alternatively two, three, four, or five, gaseous streams are withdrawn from the polymerization apparatus at different positions. In some embodiments, samples of one or more of the gaseous streams are fed subsequently to an analyzer for analyzing the sample. In some embodiments, one or more of the gaseous streams has a dedicated analyzer.

For analyzing a material composition, a gaseous stream is withdrawn from the polymerization apparatus. In some embodiments, the gaseous stream is conveyed into a sampling loop which is located close to, alternatively within, the analyzer such as the gas chromatograph. The sampling loop provides a defined volume of a gaseous sample which is then transferred into the analyzing unit. In some embodiments, the gaseous sample is transferred by an inert carrier gas. In some embodiments, the analyzer is calibrated, such that the sum of the measured components is 100%.

Passing the gaseous stream withdrawn from the polymerization apparatus through a bed of particulate solid having at the surface chemical groups which are reactive with the organometallic compound avoids the accumulation of fine solid particles within the sampling device of the analyzer and the measured sum of the components remains stable. In some embodiments, by passing the gaseous stream through a bed of particulate solid having at the surface chemical groups which are reactive with the organometallic compound, the concentration of the organometallic compound in the gas stream exiting the bed of particulate solid is less than 99%, alternatively less than 99.5%, alternatively less than 99.8%, alternatively less than 99.9%, of the concentration of the organometallic compound in the gaseous stream withdrawn from the polymerization apparatus.

In some embodiments, the bed of particulate solid is contained in a vessel having a volume of from 50 cm³ to 10 000 cm³, alternatively from 100 cm³ to 5000 cm³, alternatively from 200 cm³ to 2500 cm³.

The results obtained by the analysis of samples of the gaseous stream give information about the conditions within the polymerization apparatus. In some embodiments, the information is used to define polymerization conditions for certain grades or conditions. In some embodiments, the information is used to adapt the measured polymerization conditions to predefined values. In some embodiments, the adaptations are carried out manually by an operator or automated. In some embodiments, the information is fed as measurement signals to a controller for controlling the olefin polymerization process.

In some embodiments and between at least two polymerization zones, a gas separator is provided. As used herein, a gas separator refers to a construction that separates the reaction mixture into a gas fraction and a solid and/or liquid fraction. In some embodiments, the gas fraction is removed from the remainder of the reaction mixture. In some embodiments, the gas separator is selected from the group consisting of flash vessels, gas lock hoppers, barriers, and cyclones.

In some embodiments, at least two different types of polyethylene composition having a specified melt flow rate and different swell ratios are prepared subsequently. In some embodiments, a first type of a polyethylene composition is prepared for a specified time frame and without interruption of the process, that is, a shutdown or the like, and a further type of a polyethylene composition, having the same melt flow rate as the first type of polyethylene composition but a different swell ratio, is prepared.

In some embodiments, the polymerization process is carried out in suspension. In some embodiments, the process is carried out in a series of a first polymerization reactor and one or more subsequent polymerization reactors, wherein each polymerization reactor forms a polymerization zone. As used herein, the term “suspension polymerizations” is alternatively designated “slurry polymerizations” The suspension polymerizations take place in a medium, which is in liquid or in supercritical state under the conditions in the respective polymerization reactor and wherein the produced ethylene polymer insoluble and forms solid particles. As used herein, the term “suspension medium” is alternatively used to denote the medium. In some embodiments, the solids content of the suspension is in the range of from 10 to 80 wt. %, alternatively from 20 to 40 wt. %.

In some embodiments, the suspension medium, which forms the liquid or supercritical phase of the suspension is made from or containing a diluent and further components. In some embodiments, the further components are selected from the group consisting of dissolved monomers and comonomers, dissolved cocatalysts or scavengers, dissolved reaction auxiliaries, and dissolved reaction products of the polymerization reaction. In some embodiments, the dissolved cocatalysts or scavengers are aluminum alkyls. In some embodiments, the dissolved reaction auxiliaries are hydrogen. In some embodiments, the dissolved reaction products of the polymerization reaction are oligomers or waxes. In some embodiments, the diluents are inert, that is, do not decompose under reaction conditions. In some embodiments, the diluents are hydrocarbons having from 3 to 12 carbon atoms. In some embodiments, the diluents are saturated hydrocarbons. In some embodiments, the saturated hydrocarbons are selected from the group consisting of isobutane, butane, propane, isopentane, pentane, hexane, octane, and a mixture of these. In some embodiments, the diluent is a hydrocarbon mixture. In some embodiments, hydrocarbon mixtures have a boiling point range.

In some embodiments, the diluent has a boiling point different from the boiling points of the monomers and comonomers, thereby permitting recovery of the starting materials from a mixture by distillation. In some embodiments, the diluents are hydrocarbons having a boiling point above 40° C., alternatively above 60° C. or mixtures made from or containing hydrocarbons having the specified boiling point. In some embodiments, the polymerization takes place in a liquid suspension medium made from or containing more than 50 wt. %, alternatively more than 80 wt %, of saturated hydrocarbons having a boiling point of above 60° C. at 0.1 MPa.

In some embodiments, the slurry polymerization is performed at reactors temperatures from 60° C. to 95° C., alternatively from 65° C. to 90° C., alternatively from 70° C. to 85° C. In some embodiments, the slurry polymerization is performed at reactor pressures from 0.15 MPa to 3 MPa, alternatively from 0.2 MPa to 2 MPa, alternatively from 0.25 MPa to 1.5 MPa.

In some embodiments, a catalyst, a diluent, aluminum alkyl, ethylene and optionally, co-monomers and hydrogen are fed to the polymerization reactor, wherein the components react to form a polyethylene product suspended in a slurry. In some embodiments, the slurry also is made from or containing diluent, unreacted ethylene and wax. In the polyethylene product, polymer forms around the catalyst particles as a result of the polymerization reactions, thereby rendering the catalyst part of the polyethylene itself.

In some embodiments, the slurry polymerization is conducted in a multi-reactor cascade where the reactors are operated in series, and the catalyst remains active within the polymer as the polymer flows from reactor to reactor. In some embodiments, the slurry polymerization is conducted in a three-reactor series. In this configuration, slurry from the first reactor in the series flows to the second reactor, and slurry from the second reactor flows to the third reactor.

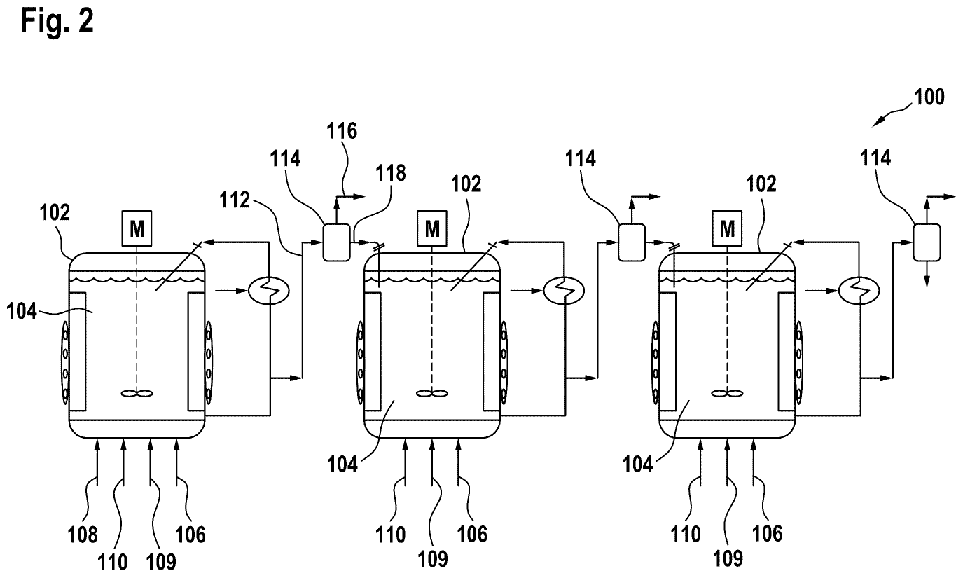

FIG. 2 is a schematic of a set-up for preparing a polyethylene composition, wherein the swell ratio of a polymer composition is controlled. The set-up includes a reactor cascade (100) including three reactors (102) operated in series.

In some embodiments, each reactor (102) of the reactor cascade (100) forms a single polymerization zone (104). In some embodiments, the reactors (102) are continuous stirred tank reactors. The diluent for polymerizing the olefins in the first polymerization reactor (102) is fed via feeding line (106) while the other components of the reaction mixture are fed to the reactor via feeding lines (108), (109), (110). In some embodiments, the other components of the reaction mixture are selected from the group consisting of catalyst, monomer, comonomers, and polymerization auxiliaries. In some embodiments, the polymerization auxiliary is hydrogen. As a result of the polymerization in reactor (1), a slurry of solid polyolefin particles in a suspension medium is formed. This slurry is fed via line (112) to the second polymerization reactor (102), wherein further polymerization occurs. In some embodiments, a gas separator (114) is between at least two subsequent reactors (102) of the reactor cascade (100). In some embodiments, the gas separator (114) separates the reactor slurry into a vapor stream that flows through line (116) and liquid slurry product that flows through line (118).

In some embodiments, the liquid slurry product flows through line (118) into a subsequent reactor (102), such that the second reactor receives the liquid slurry product from the first reactor and the third reactor receives the liquid slurry product from the second reactor. Ethylene, diluent, and optionally hydrogen and comonomer are routed to the second polymerization reactor, wherein the polymerization reaction is conducted in the slurry and thereby forms additional polyethylene. The reactor slurry of the second polymerization reactor is transferred to a second flash vessel which separates gas from the reactor slurry, with the separated liquid slurry product being routed to a third polymerization reactor. Ethylene, diluent and optionally hydrogen and comonomer are routed to the third polymerization reactor, wherein a polymerization reaction is conducted in the slurry and thereby forms additional polyethylene. The reactor slurry of the third polymerization reactor is transferred to a third flash drum which separates gas from the reactor slurry, with the liquid slurry product being forwarded for solid/liquid separation and further processing of the polymer. In some embodiments, the nature and the amount of the comonomer(s) and the hydrogen in the different reactors is the same or different.

In the first reactor, a polyethylene component having a lower average molecular weight is formed. In the second reactor, a polyethylene component having a medium average molecular weight is formed. In the third reactor, a polyethylene component having the highest polyethylene component is formed. In some embodiments and for controlling the swell ratio of the final polyethylene, the difference between the average molecular weight of the second polyethylene component of the second reactor and the average molecular weight of the first polyethylene component of the third reactor is manipulated, for example, by changing the hydrogen to ethylene ratio, by changing the reaction temperatures in the second and third reactors, or by changing both the hydrogen to ethylene ratio and the reaction temperatures in the second and third reactors. In some embodiments and as the gas fraction is removed between the two reactors, the hydrogen to ethylene content is adapted independently for each reactor. While FIG. 2 illustrates a three-reactor system, in some embodiments, the present disclosure provides a process including reactor systems containing more than three reactors.

### EXAMPLES

The following analytical methods were used to characterize the polymer compositions.

### Density

Determined according to ISO 11831-1 at 23° C.

### Melt Flow Rate MFR

Determined according to ISO 1133 at 190° C. with the specified load.

### Flow Rate Ratio

The flow rate ratio FRR is the ratio of MFR21.6/MFR2.16.

### Rheological Measurements and Calculations

Rheological measurements were performed in accordance with ASTM 4440-95a, which measured dynamic rheology data in the frequency sweep mode (plate diameter 50 mm) in a nitrogen environment, thereby minimizing the sample oxidation/degradation, with a gap in the parallel plate geometry of 1.2 to 1.4 mm and strain amplitude of 10%. Frequencies ranged from 0.0251 to 398.1 rad/sec.

ER was determined by the method described in R. Shroff and H. Mavridis, “New Measures of Polydispersity from Rheological Data on Polymer Melts,” J. Applied Polymer Science 57 (1995) 1605 (see also U.S. Pat. No. 5,534,472 at Column 10, lines 20 to 30). Storage modulus (G′) and loss modulus of (G″) were measured. The nine lowest frequency points were used (five points per frequency decade). A linear equation was fitted by least-squares regression to log G′ versus log G″. ER was then calculated from:

$$ER = ( 1.781 * {10}^{- 3} ) * {G}^{′} \\ at a value of {G}^{″} = 5 , 000 dyn / {cm}^{2} .$$

When the lowest G″ value was greater than 5,000 dyn/cm², the determination of ER involved extrapolation. The calculated ER values depended on the degree on nonlinearity in the log G′ versus log G″ plot. The temperature, plate diameter and frequency range were selected such that, within the resolution of the rheometer, the lowest G″ value was close to or less than 5,000 dyn/cm².

### Swell Ratio

The swell ratio of the polyethylene composition was measured utilizing a capillary rheometer Göttfert Rheotester2000 and Rheograph25 at T=190° C., equipped with a 30/2/2/20 die (total length 30 mm, active length=2 mm, diameter=2 mm, L/D=2/2 and 20° entrance angle) and an optical device (laser-diode from Göttfert) for measuring the extruded strand thickness. The sample was melted in the capillary barrel at 190° C. for 6 min and extruded with a piston velocity corresponding to a resulting shear-rate at the die of 1440 s⁻¹.

The extrudate was cut (by an automatic cutting device from Göttfert) at a distance of 150 mm from the die-exit, at the moment the piston reached a position of 96 mm from the die inlet. The extrudate diameter was measured with the laser-diode at a distance of 78 mm from the die-exit, as a function of time. The maximum value corresponded to the D_{extrudate}. The swell-ratio was determined from the calculation:

$$S R = ( {D}_{e x t r u d a t e} - {D}_{d i e} ) * \frac{100 \%}{{D}_{d i e}}$$

wherein D_{die} is the corresponding diameter at the die exit, measured with the laser diode.

### Environmental Stress Cracking Resistance According to Full Notch Creep Test (FNCT)

The environmental stress cracking resistance of polymer samples was determined in accordance with international standard ISO 16770 (FNCT) in aqueous surfactant solution. From the polymer sample, a compression molded 10 mm thick sheet was prepared. The bars with squared cross section (10×10×100 mm) were notched, using a razor blade, on four sides perpendicularly to the stress direction. A notching device described in M. Fleissner in Kunststoffe 77 (1987), pp. 45 was used for the sharp notch with a depth of 1.6 mm.

The load applied was calculated from tensile force divided by the initial ligament area. Ligament area was the remaining area=total cross-section area of specimen minus the notch area. For FNCT specimen: 10×10 mm²-4 times of trapezoid notch area=46.24 mm² (the remaining cross-section for the failure process/crack propagation). The test specimen was loaded with standard condition suggested by the ISO 16770 with constant load of 4 MPa at 80° C. or of 6 MPa at 50° C. in a 2% (by weight) water solution of non-ionic surfactant ARKOPAL N100. Time until rupture of test specimen was detected.

### Cast Film Measurement

The film measurement of gels was carried out on an OCS extruder type me 23.

### Example 1

A polyethylene composition was prepared in a series of a fluidized-bed reactor and a multizone circulating reactor (MZCR), having two interconnected reaction zones, as shown in FIG. 1.

11.7 g/h of a Ziegler-Natta catalyst, which was prepared as described for Example 1a in Patent Cooperation Treaty Publication No. WO 2014/202420 A1 with a molar feed ratio of electron donor/Ti of 8, were fed using 0.7 kg/h of liquid propane to a first stirred precontacting vessel, into which triisobutylaluminum (TIBA) and diethylaluminum chloride (DEAC) were dosed. The weight ratio of triisobutylaluminum to diethylaluminum chloride was 7:1. The weight ratio of the aluminum alkyls to the catalyst solid was 5:1. The first precontacting vessel was kept at 50° C. with a residence time of 30 minutes. The catalyst suspension of the first precontacting vessel was continuously transferred to a second stirred precontacting vessel, which was operated with a residence time of 30 minutes and kept at 50° C. The catalyst suspension was then transferred continuously to fluidized-bed reactor (1) via line (10).

In fluidized-bed reactor (1), ethylene was polymerized in the presence of propane as an inert diluent and using hydrogen as a molecular weight regulator. 47.5 kg/h of ethylene and 185 g/h of hydrogen were fed to the fluidized-bed reactor (1) via line (9). No comonomer was added. The polymerization was carried out at a temperature of 80° C. and a pressure of 3.0 MPa. The selected feed rates resulted in the reactor in an ethylene concentration of 10.8 vol. % and a hydrogen concentration of 29.4 vol. %. The ratio of hydrogen to ethylene present in fluidized-bed reactor (1) was accordingly 2.7.

The polyethylene component obtained in the fluidized-bed reactor (1) had an MFR2.16 of 84 g/10 min and a density of 0.967 g/cm³.

The polyethylene component obtained in fluidized-bed reactor (1) was continuously transferred to multizone circulating reactor (21), which was operated at a pressure of 2.5 MPa and a temperature of 85° C. measured at the beginning of line (29) where the reaction gas mixture left separation zone (28). The riser (22) had an internal diameter of 200 mm and a length of 19 m. The downcomer (23) had a total length of 18 m, an upper part of 5 m with an internal diameter of 300 mm and a lower part of 13 m with an internal diameter of 150 mm. The final polymer was discontinuously discharged via line (35).

To prevent the reaction gas mixture of the riser (22) from entering the downcomer (23), 330 kg/h of a liquid stream were fed as barrier fluid into the upper part of the downcomer via line (40). The liquid for generating the barrier originated from partially condensing recycle gas mixture in heat exchanger (37) at working conditions of 55° C. and 2.6 MPa and separating liquid and gaseous components in separating vessel (38). The gas for producing the liquid barrier fluid had a composition of 5.9 vol. % ethylene, 0.26 vol. % hydrogen, 0.47 vol. % 1-hexene and 93.4 vol. % propane. For dosing further monomers into the downcomer (23), additional 55 kg/h of the barrier fluid obtained in heat exchanger (37) were fed as dosing gas below the barrier to the three monomer feeding points (48), (49) and (50). The combined quantities of fresh monomers fed into the downcomer through monomer feeding points (48), (49) and (50) were 18 kg/h of ethylene and 0.93 kg/h of 1-hexene.

For reaching the targeted composition of the reaction gas mixture within the riser, 5 kg/h of propane, 27.8 kg/h of ethylene and 17 g/h of hydrogen were fed through line (51) into the recycle line (29).

Of the final polyethylene composition prepared in the series of fluidized-bed reactor (1) and multizone circulating reactor (21), 50% by weight were produced in the first reactor and 50% by weight were produced in the second reactor.

The polymerization conditions within riser (22) and downcomer (23) of multizone circulating reactor (21) are indicated in Table 1. Table 1 further reports the properties of the final polyethylene composition discharged from multizone circulating reactor (21).

### Example 2

The polymerization of Example 1 was continued under identical conditions, except that the working conditions of column (62) for generating the barrier fluid were changed, for example, by varying the amount of heat entering the column. The gas for producing the liquid barrier fluid had a composition of 0.21 vol. % hydrogen, 5.9 vol. % ethylene, 0.52 vol. % 1-hexene, and 93.4 vol. % propane.

The combined quantity of fresh monomers fed into the downcomer through monomer feeding points (48), (49) and (50) were 9 kg/h of ethylene and 1.025 kg/h of 1-hexene.

For reaching the targeted composition of the reaction gas mixture within the riser, 5 kg/h of propane, 27.8 kg/h of ethylene and 21 g/h of hydrogen were fed through line (51) into the recycle line (29).

The polymerization conditions within riser (22) and downcomer (23) of multizone circulating reactor (21) are indicated in Table 1. Table 1 further reports the properties of the final polyethylene composition discharged from multizone circulating reactor (21).

### Example 3

The polymerization of Example 2 was continued under identical conditions, except that the working of column (62) for generating the barrier fluid were changed. The gas for producing the liquid barrier fluid had a composition of 0.17 vol. % hydrogen, 6.1 vol. % ethylene, 0.52 vol. % 1-hexene and 93.2 vol. % propane.

The combined quantity of fresh monomers fed into the downcomer through monomer feeding points (48), (49) and (50) were 9 kg/h of ethylene and 1.025 kg/h of 1-hexene.

For reaching the targeted composition of the reaction gas mixture within the riser, 5 kg/h of propane, 27.8 kg/h of ethylene and 30 g/h of hydrogen were fed through line (51) into the recycle line (29).

The polymerization conditions within riser (22) and downcomer (22) of multizone circulating reactor (21) are indicated in Table 1. Table 1 further reports the properties of the final polyethylene composition discharged from multizone circulating reactor (21).

### Example 4

The polymerization of Example 3 was continued under identical conditions, except that the working of column (62) for generating the barrier fluid were changed. The gas for producing the liquid barrier fluid had a composition of 0.10 vol. % hydrogen, 5.8 vol. % ethylene, 0.49 vol. % 1-hexene and 93.6 vol. % propane.

The combined quantity of fresh monomers fed into the downcomer (23) through monomer feeding points (48), (49) and (50) were 9 kg/h of ethylene and 1.025 kg/h of 1-hexene.

For reaching the targeted composition of the reaction gas mixture within the riser, 5 kg/h of propane, 27.8 kg/h of ethylene and 33 g/h of hydrogen were fed through line (51) into the recycle line (29).

The polymerization conditions within riser (22) and downcomer (23) of multizone circulating reactor (21) are indicated in Table 1. Table 1 further reports the properties of the final polyethylene composition discharged from multizone circulating reactor (21).

TABLE 1

| | | | |
|---|---|---|---|
| Example 1 | Example 2 | Example 3 | Example 4 |

Riser

| | | | | |
|---|---|---|---|---|
| Ethylene [vol. %] | 10.1 | 9.6 | 10.2 | 10.0 |
| Hydrogen [vol. %] | 2.22 | 2.62 | 3.58 | 3.80 |
| 1-Hexene [vol. %] | 0.18 | 0.21 | 0.23 | 0.21 |
| Ratio hydrogen/ethylene | 0.22 | 0.27 | 0.35 | 0.38 |

Downcomer

| | | | | |
|---|---|---|---|---|
| Ethylene [vol. %] | 3.1 | 2.7 | 2.8 | 3.0 |
| Hydrogen [vol. %] | 0.29 | 0.24 | 0.18 | 0.10 |
| 1-Hexene [vol. %] | 0.38 | 0.40 | 0.39 | 0.41 |
| Ratio hydrogen/ethylene | 0.094 | 0.089 | 0.064 | 0.033 |

Properties of the polyethylene composition:

| | | | | |
|---|---|---|---|---|
| MFR_{21.6} [g/10 min] | 36.0 | 37.3 | 36.2 | 35.9 |
| FRR (21.6/2.16) | 82.1 | 93.3 | 100.6 | 115.8 |
| Rheological dispersity ER | 2.7 | 2.9 | 3.1 | 3.5 |
| Density [g/cm³] | 0.9529 | 0.9529 | 0.9531 | 0.9533 |
| Swell ratio [%] | 150 | 167 | 182 | 197 |
| FNCT [h] | 71 | 68 | 82 | 102 |
| OCS cast film defect area [ppm] | 3.7 | 3.8 | 3.0 | 1.8 |

The polyethylene compositions obtained in Examples 1 to 4 have the same melt flow rate MFR21 and each polyethylene composition's polyethylene component having the lowest average molecular weight obtained in the fluidized-bed reactor was the same. As such, it is believed that varying the average molecular weight of the first polyethylene component having the highest average molecular weight is counterbalanced with varying the average molecular weight of second the polyethylene component having the second-highest average molecular weight to arrive at the same melt flow rate of the final polyethylene compositions.

In Examples 1 to 4, the polyethylene components obtained in the downcomer (23) is the first polyethylene components having the highest average molecular weight and the polyethylene components obtained in the riser (22) are the second polyethylene components having the second-highest average molecular weight. When going from the conditions of Example 1 through the conditions of Examples 2 and 3 to the conditions of Example 4, the ratio hydrogen/ethylene in the downcomer decreases, that is, the concentration of hydrogen in the downcomer declines, thereby increasing the average molecular weight of the first polyethylene component having the highest average molecular weight. To counterbalance this variation and maintain the melt flow rate of the polyethylene composition, the ratio hydrogen/ethylene in the riser increases, thereby decreasing the average molecular weight of the second polyethylene component having the second-highest average molecular weight and increasing the difference between the average molecular weight of the first polyethylene component having the highest average molecular weight and the average molecular weight of the second polyethylene component having the second-highest average molecular weight.

The data of Table 1 show that the increase in the molecular weight difference between the average molecular weight of the first polyethylene component and the average molecular weight of the second polyethylene component at an unchanged melt flow rate of the final polyethylene composition effects an increase of the swell ratio from 150% to 197%, without impacting the further property profile polyethylene compositions.

The data of Table 1 also demonstrate that, vice versa, when going from Example 4 to Example 1, a decrease of the swell ratio is effected when decreasing the difference between the average molecular weight of the first polyethylene component and the average molecular weight of the second polyethylene component.

In some embodiments and during a continuous process, the process switches between product grades, having the same melt flow rate, density, or both and different swell ratios, without shutting down and restarting the process. In some embodiments and by adjusting the differences between the average molecular weight of the first polyethylene component and the average molecular weight of the second polyethylene component, the process runs continuously while switching from one grade to another. In some embodiments, the differences between the average molecular weight are adjusted by modifying the ratio of hydrogen to ethylene, by modifying the temperature in the respective polymerization zones, or both.

1. A process for controlling the swell ratio of a multimodal polyethylene composition having a specified melt flow rate, comprising the steps of:
preparing the polyethylene composition in a polymerization apparatus comprising three or more polymerization zones in the presence of a polymerization catalyst and hydrogen as molecular weight regulator; and
selecting different ratios of hydrogen to ethylene in the polymerization zones, thereby forming, in the polymerization zones, three or more polyethylene components which differ in the average molecular weight,
wherein one of the polyethylene components prepared in one of the polymerization zones has the highest average molecular weight and one of the polyethylene components prepared in another one of the polymerization zones has the second-highest average molecular weight, wherein
for increasing the swell ratio, the difference between the average molecular weight of the polyethylene component having the highest average molecular weight and the average molecular weight of the polyethylene component having the second-highest average molecular weight is increased, and
for decreasing the swell ratio, the difference between the average molecular weight of the polyethylene component having the highest average molecular weight and the average molecular weight of the polyethylene component having the second-highest average molecular weight is decreased.

2. The process of claim 1, wherein the step of increasing or decreasing the difference between the average molecular weight of the polyethylene component having the highest average molecular weight and the average molecular weight of the polyethylene component having the second-highest average molecular weight is or includes a step of modifying the ratio of hydrogen to ethylene in the polymerization zones in which the polyethylene component having the highest average molecular weight is prepared or in the polymerization zones in which the polyethylene component having the second-highest average molecular weight is prepared.

3. The process of claim 1, wherein the step of increasing or decreasing the difference between the average molecular weight of the polyethylene component having the highest average molecular weight and the average molecular weight of the polyethylene component having the second-highest average molecular weight is or includes a step of changing the temperature in the polymerization zones in which the polyethylene component having the highest average molecular weight is prepared or in the polymerization zones in which the polyethylene component having the second-highest average molecular weight is prepared.

4. The process of claim 1, wherein, for keeping the melt flow rate of the polyethylene composition at the specified value while increasing or decreasing the difference between the average molecular weight of the polyethylene component having the highest average molecular weight and the average molecular weight of the polyethylene component having the second-highest average molecular weight, the polymerization conditions in one or more polymerization zones which are neither the polymerization zone, in which the polyethylene component having the highest average molecular weight is prepared, nor the polymerization zone, in which the polyethylene component having the second-highest average molecular weight is prepared, are changed.

5. The process of claim 1, wherein, for keeping the melt flow rate of the polyethylene composition at the specified value while increasing or decreasing the difference between the average molecular weight of the polyethylene component having the highest average molecular weight and the average molecular weight of the polyethylene component having the second-highest average molecular weight, the polymerization conditions in the polymerization zone, in which the polyethylene component having the second-highest average molecular weight is prepared, is changed.

6. The process of claim 5, wherein the polymerization conditions in one or more polymerization zones, which are neither the polymerization zone, in which the polyethylene component having the highest average molecular weight is prepared, nor the polymerization zone, in which the polyethylene component having the second-highest average molecular weight is prepared, are kept constant.

7. The process of claim 1, wherein the polymerization apparatus comprises a series of at least three subsequent polymerization reactors.

8. The process of claim 1, wherein the polymerization apparatus comprises a series of a fluidized-bed reactor and a multizone circulating reactor.

9. The process of claim 1, wherein a gas separator is provided between at least two polymerization zones, the gas separator removing a gas fraction of the reaction mixture between the at least two polymerization zones.

10. A process for preparing at least two types of polyethylene composition having a specified melt flow rate and different swell ratios, the process comprising polymerizing ethylene in the presence of a polymerization catalyst and hydrogen as a molecular weight regulator in a series of polymerization reactors comprising three or more polymerization zones, wherein the polymerization zones differ in the ratio of hydrogen to ethylene present in the polymerization zones and so forming, in the polymerization zones, three or more polyethylene components which differ in the average molecular weight, wherein one of the polyethylene components prepared in one of the polymerization zones has the highest average molecular weight and one of the polyethylene components prepared in another one of the polymerization zones has the second-highest average molecular weight, wherein for increasing the swell ratio, the difference between the average molecular weight of the polyethylene component having the highest average molecular weight and the average molecular weight of the polyethylene component having the second-highest average molecular weight is increased, and for decreasing the swell ratio, the difference between the average molecular weight of the polyethylene component having the highest average molecular weight and the average molecular weight of the polyethylene component having the second-highest average molecular weight is decreased.

11. The process of claim 10, wherein the at least two polyethylene compositions are prepared subsequently.

12. The process of claim 10, wherein at least one of the at least two polyethylene compositions is a high density polyethylene composition having a density of from 0.940 to 0.968 g/cm³.
